(19) United States
(12) Patent Application Publication
(10) Pub. No.: US 2017/0352126 A1
(43) Pub. Date: Dec. 7, 2017

(54) METHOD FOR MARKETING COSMETIC PRODUCTS

(71) Applicant: Sharon Simpson, Spanish Fort, AL (US)

(72) Inventor: Sharon Simpson, Spanish Fort, AL (US)

(21) Appl. No.: 15/171,070

(22) Filed: Jun. 2, 2016

(51) Int. Cl. G06Q 99/00; B65B 5/00; A45D 40/24; B65D 33/25; A45D 40/00

(52) U.S. Cl. CPC G06Q 99/00; B65D 33/2508; A45D 40/0087; A45D 40/24; B65B 5/00

(57) ABSTRACT

An improved method for marketing cosmetic products is provided. The method allows cosmetic brands to more effectively monetize cosmetic samples by reaching a larger segment of consumers. In accordance with the proposed method, a variety of sample-sized cosmetic products are packaged into a single container and sold to a consumer as a unit. The unit is suitable for airline travel and provides all the necessary cosmetics one would need on a trip in a single unit.

### FIELD OF THE INVENTION

A preferred embodiment of the present invention refers to a method for marketing cosmetic products to consumers.

### BACKGROUND

The cosmetics industry is a multi-billion dollar industry selling a variety of products including makeup, makeup remover, skin care products, and hair care products, among others. The cost of any particular type of cosmetic can vary significantly depending on the brand, with many cosmetics consumers regularly purchasing only those cosmetics within a certain price range.

Most cosmetics brands, whether expensive or inexpensive, offer free samples to consumers to market the brand. Samples may be distributed to consumers in person, such as in a retail store, or by other methods, such as through mailings. However, problems exist in the way cosmetics are currently marketed through the distribution of free samples. For instance, prestige and luxury brands may offer free samples, but many consumers ultimately never purchase the brands' products due to the expensive price of the full size, non-sample products available for sale, even if the consumer likes the quality of the sample products. Thus, many prestige and luxury brands do not effectively monetize their products because a large segment of cosmetics consumers do not purchase the brands solely because of price.

In addition, a consumer may wish to have a variety of small, sample-sized cosmetic products for purposes such as travel. For travel, a user typically needs to transport many different types of cosmetics for a single trip. However, it is inconvenient for a consumer to obtain free samples of all the different cosmetics needed for travel, and many of the cosmetics necessary for a trip may not be available for sale in sample sizes or similarly small-sized portions.

Accordingly, there is a need in the art for an improved method of marketing cosmetic products in a manner that effectively monetizes products by reaching a larger segment of consumers.

In addition, there is a need in the art for an improved method of supplying cosmetic products to consumers for travel.

### SUMMARY

A preferred embodiment of the invention is directed to an improved method of marketing cosmetic products. In accordance with the proposed method, a plurality of cosmetic products are packaged into a single container and sold to a consumer as a unit. Each individually packaged cosmetic product is a sample-sized cosmetic product such as a foundation, a blush, a concealer, eyeliner, mascara, makeup remover, or similar types of cosmetics or skincare products. The unit of cosmetics provides a variety of different types of cosmetics so that a single container unit includes substantially all of the cosmetics that a user would need for a period of at least several days. Thus, the packaged unit is particularly advantageous for travelers. In a preferred embodiment, the container is a transparent plastic bag, preferably having a capacity of no more than about one quart and having a zipper for opening and closing the bag. In addition, each sample comprising a cosmetic in the form of a liquid, aerosol, gel, cream, or paste is less than about 100 milliliters in volume. This embodiment provides a complete unit of cosmetic samples that complies with current Transportation Security Administration (TSA) regulations for carry-on luggage on U.S. flights while also providing the user with all of the cosmetics needed for a trip in a single carry-on container priced as a single unit.

In addition, in some embodiments, the container unit of cosmetic products includes luxury or prestige cosmetic products in sample sizes that are not currently available for sale to consumers. Because the sample sizes are relatively small compared to the full sizes currently available for sale, a larger segment of consumers can afford to purchase more expensive brands for at least some of the consumer's cosmetic purchases. Therefore, the marketing method of the present invention allows luxury or prestige cosmetic brands to reach a larger segment of consumers and to increase overall sales. Thus, the proposed method allows some brands, particularly brands that are relatively expensive, to more effectively monetize sample-sized products that are currently given to consumers free of charge for marketing purposes.

Accordingly, one object of the present invention is to provide an improved method of marketing cosmetic products in a manner that more effectively monetizes sample-sized products currently offered to consumers for free by reaching a larger segment of consumers willing to pay for those products.

Another object of the present invention is to provide an improved method of supplying cosmetic products to consumers for travel so that a consumer can purchase a unit of cosmetic products that includes all the products needed by the consumer for a period of up to about one week.

### DESCRIPTION OF THE DRAWINGS

These and other features, aspects, and advantages of the present invention will become better understood with regard to the following description, appended claims, and accompanying drawings where:

FIG. 1 shows a perspective view of a carrying container that may be utilized in accordance with the present invention.

FIG. 2 shows a side elevational view of a carrying container that may be utilized in accordance with the present invention.

FIG. 3 shows a top plan view of a carrying container that may be utilized in accordance with the present invention.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

The term “prestige,” “luxury” and “drug store” cosmetic products refer to tiers of cosmetic brands. Generally, luxury products are top-tier and include brands such as YVES SAINT LAURENT, GUERLAIN, CHRISTIAN LOUBOUTIN, and the like. Prestige products are middle-tier and include brands such as URBAN DECAY, BENEFIT, MAC, and STILA. Prestige or luxury cosmetics may be differentiated from drug store cosmetic products such as L'OREAL, MAYBELLINE, REVLON, and the like. Prestige or luxury cosmetic products are generally available at department stores such as NORDSTROM, MACY'S, SAKS FIFTH AVENUE, BELK, and the like. Drug store cosmetic brands are generally available at mass-market stores such as WALMART, WALGREEN'S, RITE-AID, and the like.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

A preferred embodiment of the invention is directed to an improved method of marketing cosmetic products to more effectively monetize cosmetic samples by reaching a larger segment of consumers. In accordance with the proposed method, a plurality of cosmetic products are packaged into a single container and sold to a consumer as a unit. As used herein, the term “cosmetic products” may refer to any type of makeup, cosmetics, makeup remover, skin care products, hair care products, or any similar products applied to a user's skin, hair, nails, or lips. For instance, cosmetic products may include, but are not limited to, makeup, makeup remover, foundation, blush, concealer, eyeliner, eye shadow, mascara, face powder, lipstick, lip liner, nail polish, primer, makeup setting spray, perfume, moisturizer, shampoo, conditioner, hair gel, sunscreen or similar types of products. In addition, cosmetic products may also include various products used for the application of cosmetics, such as brushes, sponges, makeup pencils such as a lip liner pencil, applicators such as a mascara wand applicator, or similar application devices.

Cosmetic products may come in a variety of forms and may include solids, semi-solid substances, or liquids, such as powders, waxes, gels, creams, pastes, aerosols, or mousse. Individual samples of cosmetic products may be packaged in jars, tubes, bottles, or similar types of containers. Other types of cosmetics samples may be available as sample cards having a small amount of the cosmetic applied to the card so that the user can access the cosmetic using an applicator or similar device and then apply the cosmetic onto the user from the applicator.

Each cosmetic product is individually packaged in a sample-sized portion before the samples are packaged into a single container for sale as a unit. As used herein, the terms “sample,” “sample size,” or similar terms may refer to any cosmetic product containing a relatively small amount of a cosmetic sufficient to last for up to about one week when used on a daily basis. For cosmetics in the form of a liquid or a similar liquefied or semi-solid substance, individual samples preferably have a volume of no more than about 100 milliliters per sample. Solid samples preferably have a weight of no more than about one ounce.

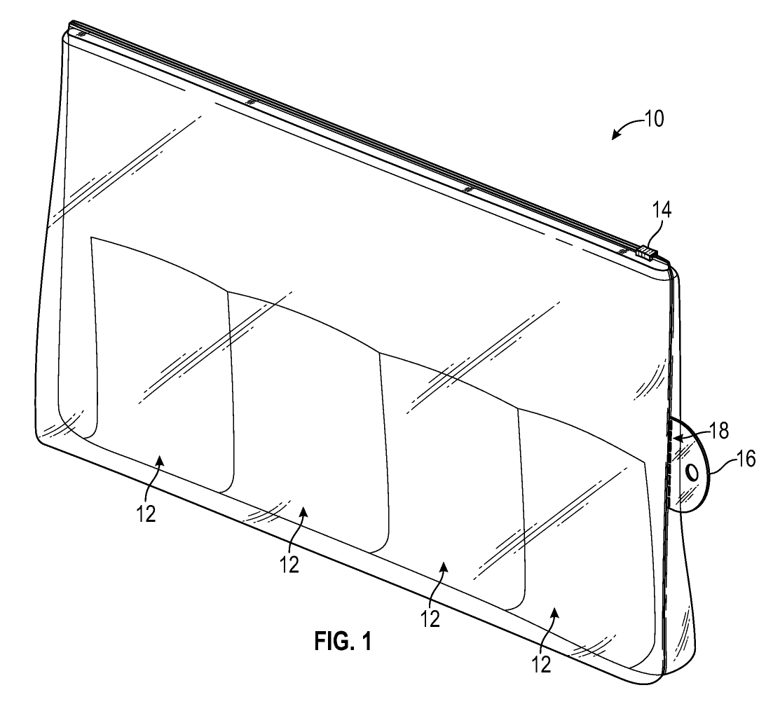

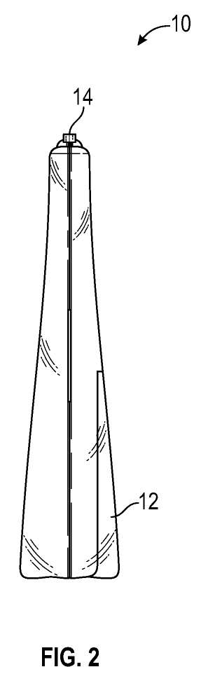

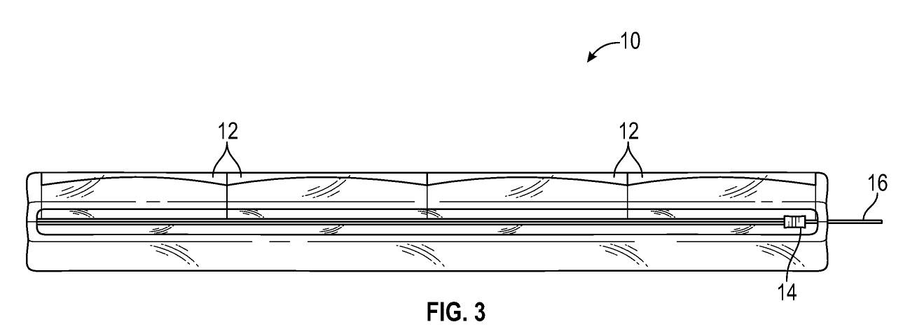

FIGS. 1-3 show one example of a carrying bag 10 that may be utilized in accordance with the proposed method. The plurality of cosmetic samples are all packaged into the bag 10, and the bag 10, including the cosmetic samples, is priced and offered for sale as a single unit. For ease of illustration, FIGS. 1-3 show the bag 10 without cosmetic samples packaged therein. The bag 10 is preferably a transparent bag and preferably has a zipper 14 for opening and closing the bag 10. In addition, the bag 10 preferably comprises a plurality of internal pockets 12 for holding implements and applicators such as brushes, tweezers, and the like. Alternatively, internal pockets 12 may house at least a portion of the individual samples packaged within the bag. In another preferred embodiment, as best seen in FIG. 1, the bag 10 comprises a tab 16 attached thereto. The tab 16 has a hole therethrough for hanging the bag 10 and is preferably attached via perforations 18 so that the user can remove the tab 16, if desired.

A variety of different types of cosmetics are packaged into the bag 10 so that a single bag 10 includes substantially all of the cosmetics that a user would typically need for a period of at least several days. In a preferred embodiment, the contents of the bag 10 comprise at least one of the following types of cosmetic products: a foundation, a concealer, a blush, at least one cosmetic for application to the eye area, such as mascara, eyeliner, or eye shadow, and at least one cosmetic for application to the lips, such as lipstick, lip gloss, or lip liner. Thus, the packaged unit comprising sample sizes of various types of cosmetics generally provides the user with a unit of cosmetics sufficient to substantially cover all cosmetic needs for a period of a week or more. Accordingly, the packaged unit is particularly advantageous for travelers because a single unit can be purchased to cover all the traveler's needs. In a preferred embodiment, the bag 10 has a capacity of no more than about one quart, and each sample has a volume of no more than about 100 milliliters. Thus, a user can carry the bag 10 containing all the cosmetic samples onto any flight in the United States in compliance with current Transportation Security Administration (TSA) regulations for carry-on luggage.

In addition, in some embodiments, the bag 10 of cosmetic products includes prestige or luxury brand cosmetic products in sample sizes that are not currently available for sale to consumers. Because the sample sizes are relatively small compared to the sizes of cosmetics available for sale, a larger segment of consumers can afford to purchase prestige or luxury brands for at least some of a consumer's cosmetic purchases. Therefore, the marketing method of the present invention provides cosmetic brands with the potential to reach a larger segment of consumers and to increase overall sales of cosmetics. Thus, the proposed method allows some brands, particularly prestige or luxury brands that are relatively expensive, to more effectively monetize sample-sized products that are currently given to consumers free of charge for marketing purposes.

As disclosed herein, a preferred method of marketing cosmetic products utilizes a plurality of cosmetic samples. Generally, these cosmetic samples may be different types of cosmetics and may be liquids, aerosols, gels, creams, or pastes. Additionally, in other embodiments these cosmetics may be from different manufacturers. Alternatively, the cosmetics may be from a drug store, prestige or luxury line of products. In the case of different manufacturers' sample products being marketed together, generally the cosmetic samples come from at least two manufacturers, the first manufacturer offering prestigious or luxurious cosmetics and the second manufacturer offering drug store cosmetics. It is understood that more than two manufacturers' products may be marketed together and still fall within the scope of the claimed invention.

Using this method, manufacturers of prestige or luxury brands will be better able to effectively monetize their products because a much larger segment of cosmetics consumers will be able to afford the brand's smaller size offerings. Additionally, this method will help solve the problem of prestige or luxury offering free samples, but many consumers ultimately never purchase the brand's products due to the expensive price of the full size, non-sample products available for sale, even if the consumer likes the quality of the sample products. Additionally, marketing prestige or luxury brand products along with drug store cosmetics allows the overall set of products to be sold at a more affordable price than a full set of prestige or luxury brand products. Additionally, prestige or luxury brand cosmetics are generally not available at drug stores due to the high price. Utilizing the methods set forth herein will solve this problem and will provide prestige or luxury brands an outlet to better market their products.

It is understood that the container may be any color or material. Nonetheless, a preferred embodiment of the method utilizes a transparent or translucent bag or case.

It is understood that the container may use any available mechanism for closing and securing the bag. For example, the container may be closed with Velcro, adhesive, buttons, hook and loops, or the like. Nonetheless, a preferred embodiment of the method utilizes a zipper for opening and closing the bag. In a preferred embodiment, the zipper may include a security element attached from the zipper to the bag. The security element will be used to deter consumers from opening the bag when on the shelves.

Utilizing a preferred embodiment of the method helps consumers who need to have a variety of small, sample-sized cosmetic products for purposes such as travel. For travel, a user typically needs to transport many different types of cosmetics for a single trip, and many of the cosmetics necessary for a trip may not be available for sale in sample sizes or similarly small-sized portions. A method of this invention is based on packaging all the different cosmetics needed for travel. In a preferred embodiment, the bag or case utilizing the method has a capacity of no more than about one quart. For travel, it is preferred, that each sample comprising a liquid, aerosol, gel, cream, or paste has a volume of no more than about 100 milliliters.

It is understood that versions of the invention may come in different forms and embodiments. Additionally, it is understood that one of skill in the art would appreciate these various forms and embodiments as falling within the scope of the invention as disclosed herein.

What is claimed is:

1. A method of marketing cosmetic products, said method comprising the steps of:
providing a plurality of cosmetic samples, wherein the plurality of cosmetic samples are a plurality of different types of cosmetics,
packaging all of the samples into a single container,
pricing the container and samples as a unit, and
offering the unit for sale to a consumer.

2. The method of claim 1, wherein the single container has a plurality of pockets and the samples are placed in the plurality of pockets of the container.

3. The method of claim 2, wherein the samples come from at least two groups, the first group being prestige or luxury cosmetics and the second group being drug store cosmetics.

4. The method of claim 2, wherein the container is a transparent plastic bag.

5. The method of claim 2, wherein the container has a capacity of about one quart.

6. The method of claim 2, wherein the container has a zipper configured for opening and closing the container.

7. The method of claim 2, wherein at least a portion of the plurality of samples comprises a liquid, aerosol, gel, cream, or paste.

8. The method of claim 7, wherein each sample comprising a liquid, aerosol, gel, cream, or paste has a volume of no more than about 100 milliliters.

9. A method of marketing prestige and luxury cosmetic products at a lower price point, said method comprising the steps of:
Providing a transparent container having a plurality of separate pockets
providing a plurality of cosmetic samples, wherein the plurality of cosmetic samples are prestige or luxury cosmetic samples not generally available in department stores,
packaging the plurality of cosmetic samples in each of the plurality of pockets such that each cosmetic sample is visible, wherein the cosmetic samples make up a full set of cosmetics needed for approximately one week of regular use,
pricing the container and samples as a unit, and
offering the unit for sale to a consumer.

10. The method of claim 10, wherein the cosmetic samples come from at least two groups, the first group being prestige or luxury cosmetics and the second group being drug store cosmetics.

11. The method of claim 9, wherein the container is a transparent plastic bag.

12. The method of claim 9, wherein the container has a capacity of about one quart.

13. The method of claim 9, wherein the container has a zipper configured for opening and closing the bag.

14. The method of claim 9, wherein at least a portion of the plurality of samples comprises a liquid, aerosol, gel, cream, or paste.

15. A method of providing a plurality of cosmetic samples suitable for carrying onto an airplane, wherein
the plurality of cosmetic samples are different types of cosmetics,
said cosmetics comprising at least one of a liquid, aerosol, gel, cream or paste, and
said liquid, aerosol, gel, cream, or paste have a volume of less than 100 milliliters.
packaging all of the cosmetics into a single container,
pricing the container and cosmetics as a unit, and
offering the unit for sale to a consumer.

16. The method of claim 15, wherein the container is a transparent plastic bag.

17. The method of claim 15, wherein the container has a capacity of about one quart.

18. The method of claim 15, wherein the container has a zipper configured for opening and closing the container.

19. The method of claim 15, wherein at least a portion of the plurality of samples comprises a liquid, aerosol, gel, cream, or paste.
